(19) United States
(12) Patent Application Publication
(10) Pub. No.: US 2015/0001777 A1
(43) Pub. Date: Jan. 1, 2015

(54) POSITIONING DEVICE WITH MANUAL CONTROL MECHANISM

(71) Applicants: Fu Tai Industry (Shenzhen) Co., Ltd., Shenzhen (CN); HON HAI PRECISION INDUSTRY CO., LTD., New Taipei (TW)

(72) Inventor: CHANG-HAI HUANG, Shenzhen (CN)

(21) Appl. No.: 14/314,748

(22) Filed: Jun. 25, 2014

(30) Foreign Application Priority Data
Jun. 27, 2013 (CN) 2013102601501

(51) Int. Cl. B23Q 1/28; B23Q 1/62

(52) U.S. Cl. CPC B23Q 1/28; B23Q 1/62
USPC 269/73

(57) ABSTRACT

A positioning device includes a base and a manual control mechanism. The manual control mechanism includes an X-axis control mechanism, a Y-axis control mechanism, and an operation platform. The X-axis control mechanism includes a position limiting plate and a latching pin. The position limiting plate is arranged along an X axis and defines a plurality of X-axis position limiting holes. The latching pin is configured to be alternatively inserted into one of the plurality of X-axis position limiting holes. The Y-axis control mechanism includes a position limiting plate and a latching pin. The position limiting plate is arranged along a Y axis and defines a plurality of Y-axis position limiting holes. The Y axis is perpendicular to the X axis. The latching pin of the Y-axis control mechanism is configured to be alternatively inserted into one of the plurality of Y-axis position limiting holes.

### FIELD

The subject matter herein generally relates to positioning devices, and particularly to a positioning device with manual control mechanism.

### BACKGROUND

Positioning devices can be semi-automatic and include a server and motors to move an operation platform. However, the positioning device occupies a large space.

### BRIEF DESCRIPTION OF THE DRAWINGS

Implementations of the present technology will now be described, by way of example only, with reference to the attached figures.

FIG. 1 is an assembled, isometric view of an embodiment of a positioning device including an X-axis position setting mechanism and a Y-axis position setting mechanism.

FIG. 2 is an exploded, isometric view of the positioning device in FIG. 1.

FIG. 3 is an exploded, isometric view of the X-axis position setting mechanism in FIG. 1.

FIG. 4 is an exploded, isometric view of the Y-axis position setting mechanism of FIG. 1.

FIG. 5 is a cross-sectional view taken alone a line IV-IV of FIG. 1.

FIG. 6 is an enlarged view of a circled portion V of FIG. 5

FIG. 7 is similar to FIG. 6, but in another state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a positioning device including a base, an extension arm fixed to the base, a Z-axis control mechanism located on the extension arm, a pressing member located on the Z-axis control mechanism, and a manual control mechanism. The manual control mechanism includes an X-axis control mechanism, a Y-axis control mechanism, and an operation platform. The X-axis control mechanism includes a position limiting plate and a latching pin. The position limiting plate is arranged along an X-axis and defines a plurality of X-axis position limiting holes. The latching pin is configured to be alternatively inserted into one of the plurality of X-axis position limiting holes. The Y-axis control mechanism includes a position limiting plate and a latching pin. The position limiting plate is arranged along a Y-axis and defines a plurality of Y-axis position limiting holes. The Y-axis is perpendicular to the X-axis. The latching pin of the Y-axis control mechanism is configured to be alternatively inserted into one of the plurality of Y-axis position limiting holes.

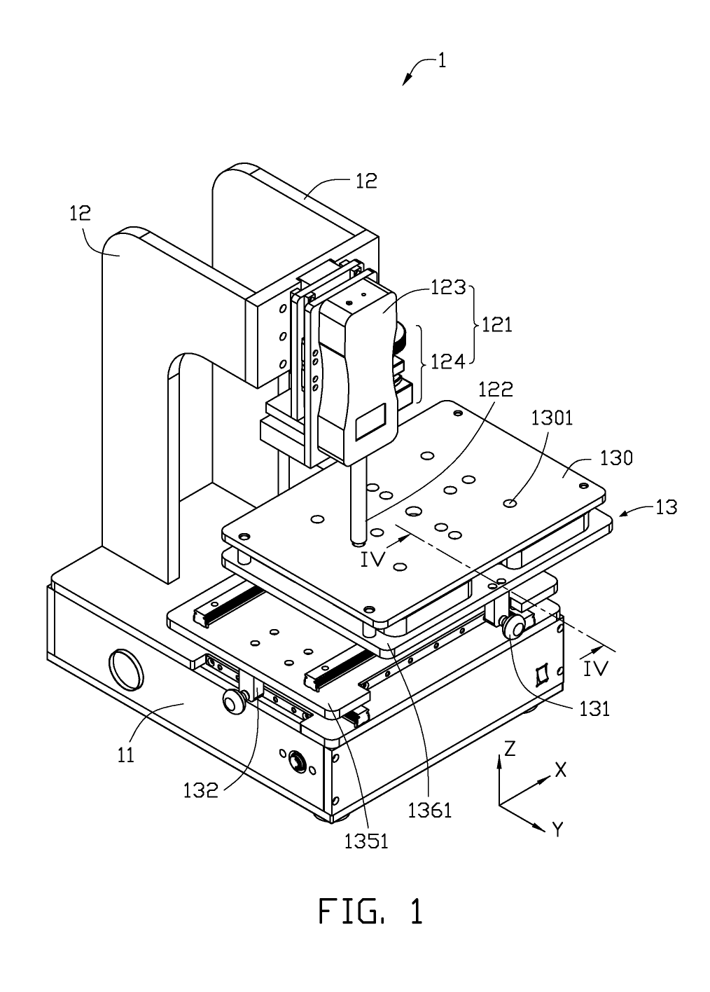

FIG. 1 illustrates an embodiment of a positioning device 1. The positioning device 1 includes a base 11, a substantially L-shaped extension arm 12, and a manual control mechanism 13. A first end portion of the extension arm 12 can be substantially perpendicularly fixed to the base 11. The manual control mechanism 13 can be located between the base 11 and a second end portion of the extension arm 12. In the illustrated embodiment, an XYZ-coordinate system is used to describe orientations of the positioning device 1.

The manual control mechanism 13 can include an operation platform 130, an X-axis control mechanism 131, a Y-axis control mechanism 132, a first fixing plate 1351, and a second fixing plate 1361. The operation platform 130 can be located above the first fixing plate 1351 and the second fixing plate 1361. The second fixing plate 1361 can be substantially parallel to the first fixing plate 1351. The positioning device 1 can further include a Z-axis control mechanism 121 located on the extension arm 12. A pressing member 122 can be coupled to the Z-axis control mechanism 121. The Z-axis control mechanism 121 can include a macro-adjusting mechanism 123, and a micro-adjusting mechanism 124 coupled to the macro-adjusting mechanism 123. The pressing member 122 can be coupled to the macro-adjusting mechanism 123. The macro-adjusting mechanism 123 can be configured to broadly adjust a Z-coordinate position of the pressing member 122. The micro-adjusting mechanism 124 can be configured to precisely adjust the Z-coordinate position of the pressing member 122.

In this embodiment, a workpiece (not shown) can be positioned below the operation platform 130, and above the X-axis control mechanism 131 and the Y-axis control mechanism 132. The operation platform 130 can define a plurality of through holes 1301. The pressing member 122 can be moved by the macro-adjusting mechanism 123 and the micro-adjusting mechanism 124 to pass through a corresponding through hole 1301 and press the workpiece. A deformation of the workpiece produced by the pressing of the pressing member 122, in addition to a force applied by the pressing member 122, can be used to determine a hardness of the workpiece.

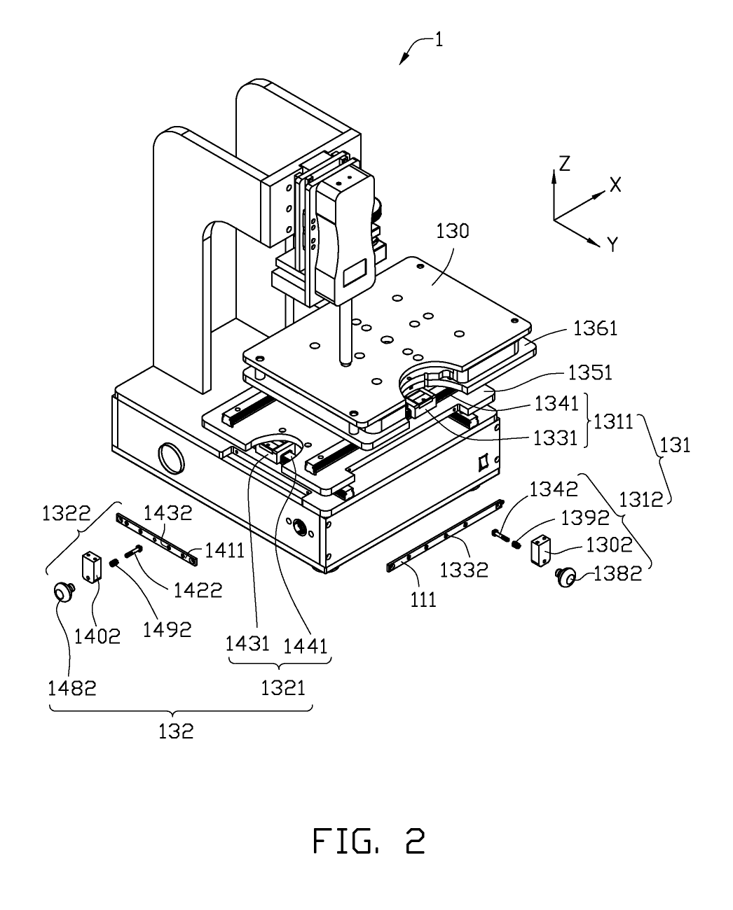

Referring to FIG. 2, the X-axis control mechanism 131 can include an X-axis guiding mechanism 1311 and an X-axis position setting mechanism 1312. The X-axis guiding mechanism 1311 can adjust a position of the second fixing plate 1361 and of the operation platform 130 along the X-axis.

The X-axis guiding mechanism 1311 can include an X-axis guiding member 1331 and an X-axis guiding rail 1341. The X-axis guiding rail 1341 can be located on a top surface of the first fixing plate 1351. The X-axis guiding member 1331 can be coupled to a bottom surface of the second fixing plate 1361. Thus, the X-axis guiding rail 1341 can engage the X-axis guiding member 1331 to allow the second fixing plate 1361 to move along the X-axis. The operation platform 130 can be coupled to a top surface of the second fixing plate 1361. Thus, the operation platform 130 can move together with the second fixing plate 1361 along the X-axis.

The X-axis position setting mechanism 1312 can include a position limiting plate 111 arranged along the X-axis, and a latching pin 1342. The position limiting plate 111 can be located on a side surface of the first fixing plate 1351 corresponding to the X-axis. The position limiting plate 111 can define a plurality of X-axis position limiting holes 1332 arranged along the X-axis.

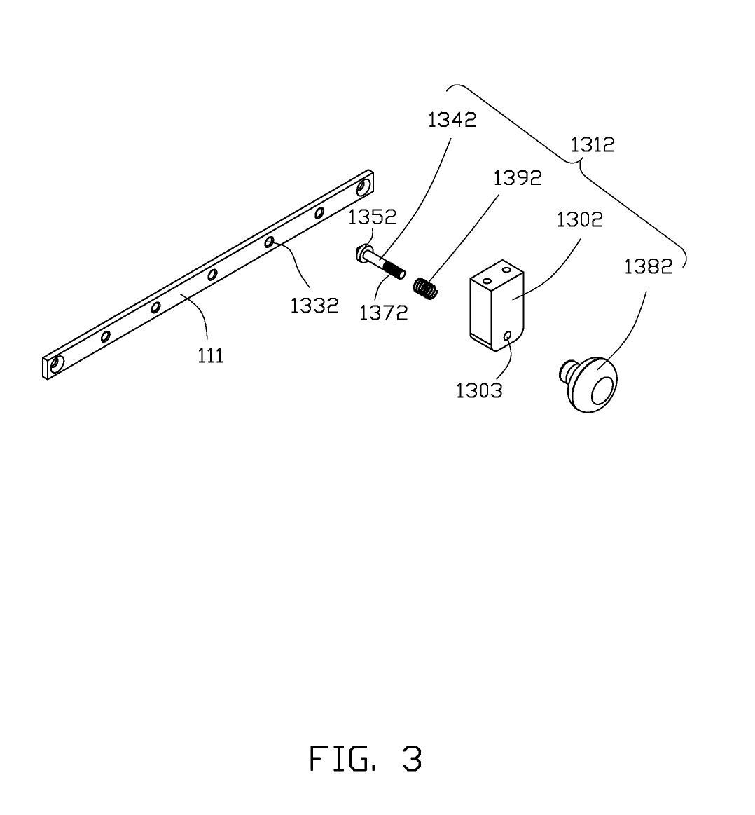

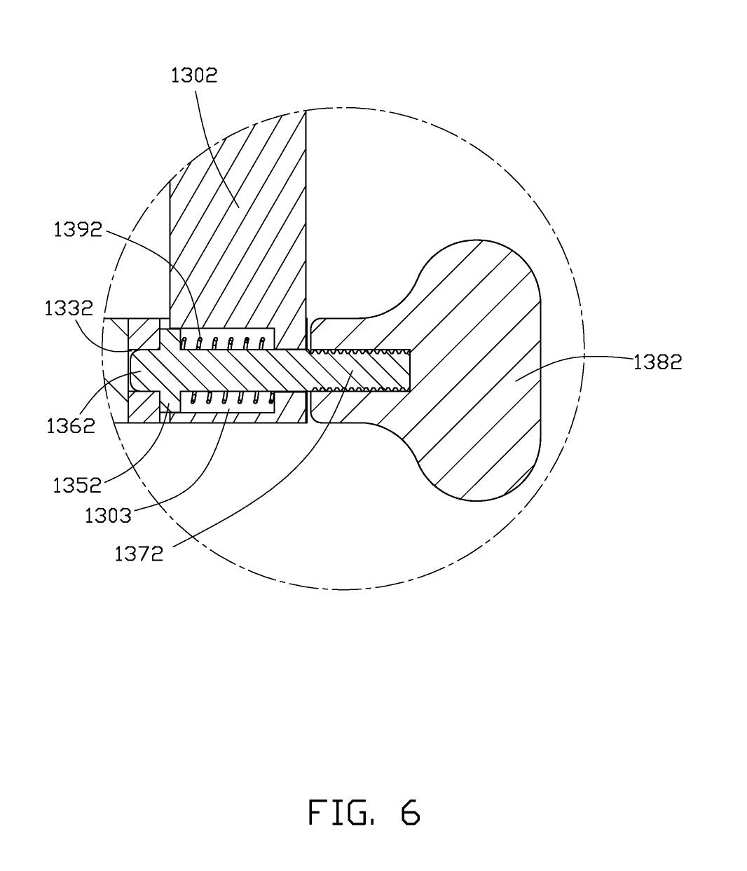

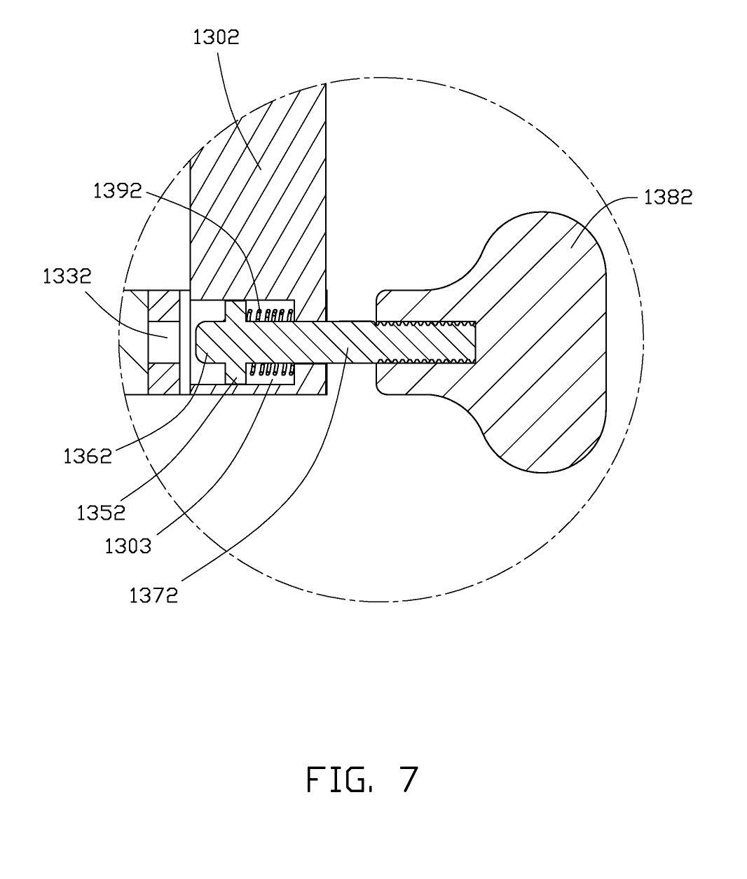

Referring to FIG. 3, the latching pin 1342 can include a blocking portion 1352, a post 1362 (shown in FIGS. 6 and 7), and a threaded coupling portion 1372. The blocking portion 1352 protrudes radially from the latching pin 1342. The post 1362 and the threaded coupling portion 1372 can be located at respective opposite sides of the blocking portion 1352. The post 1362 can protrude through one of the plurality of X-axis position limiting holes 1332. A size of the blocking portion 1352 can be larger than sizes of the post 1362 and threaded coupling portion 1372. The X-axis position setting mechanism 1312 can further include a button 1382. The button 1382 can be threaded with the threaded coupling portion 1372 of the latching pin 1342. In the illustrated embodiment, the blocking portion 1352 can be circular. In an alternative embodiment, the blocking portion 1352 can be other shapes.

The X-axis position setting mechanism 1312 can further include a guiding block 1302. The guiding block 1302 can be fixed to the second fixing plate 1361. The guiding block 1302 can define a stepped through hole 1303. The stepped through hole 1303 can include a wide portion and a narrow portion (both shown in FIGS. 6-7). A size of the blocking portion 1352 can be substantially equal to a size of the wide portion of the stepped through hole 1303. The threaded coupling portion 1372 can pass through the stepped through hole 1303 and thread with the button 1382. When the latching pin 1342 is inserted into one of the X-axis position limiting holes 1332, movement of the second fixing plate 1361 and of the operation platform 130 is restricted along the X-axis. Thus, the second fixing plate 1361 and the operation platform 130 are positioned along the X-axis. When the latching pin 1342 is removed from the corresponding X-axis position limiting hole 1332, a position of the second fixing plate 1361 and of the operation platform 130 can be adjusted along the X-axis.

The X-axis position setting mechanism 1312 can further include an elastic member 1392. The elastic member 1392 can be sleeved on the threaded coupling portion 1372 of the latching pin 1342. A first end portion of the elastic member 1392 can resist against the blocking portion 1352, and a second end portion of the elastic member 1392 can resist against a boundary between the wide portion and the narrow portion of the stepped through hole 1303 of the guiding block 1302 (shown in FIG. 6). In the illustrated embodiment, the elastic member 1392 can be a spring.

Referring again to FIG. 2, the Y-axis control mechanism 132 can include a Y-axis guiding mechanism 1321 and a Y-axis position setting mechanism 1322. The Y-axis guiding mechanism 1321 can adjust a position of the first fixing plate 1351 along the Y-axis, and thereby adjust a position of the second fixing plate 1361 and of the operation platform 130 along the Y-axis.

The Y-axis guiding mechanism 1321 can include a Y-axis guiding member 1431 and a Y-axis guiding rail 1441. The Y-axis guiding rail 1441 can be located on a top surface of the base 11, and the Y-axis guiding member 1431 can be coupled to a bottom surface of the first fixing plate 1351. Thus, the Y-axis guiding rail 1441 can engage with the Y-axis guiding member 1431 to allow the first fixing plate 1351 to move along the Y-axis. Because the second fixing plate 1361 and the operation platform 130 are coupled to the first fixing plate 1351, the operation platform 130 and the second fixing plate 1361 can move together with the first fixing plate 1351 along the Y-axis. The Y-axis position setting mechanism 1322 can include a position limiting plate 1411 arranged along the Y-axis, and a latching pin 1442. The position limiting plate 1411 can be located on a side surface of the base 11 corresponding to the Y-axis. The position limiting plate 1411 can define a plurality of Y-axis position limiting holes 1432 arranged along the Y-axis.

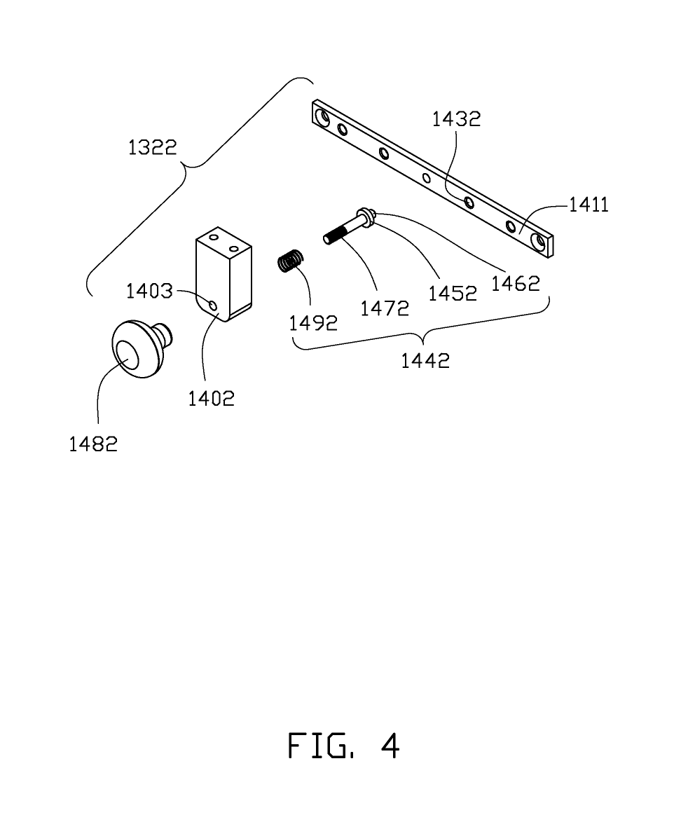

Referring to FIG. 4, the latching pin 1442 can include a blocking portion 1452, a post 1442, and a threaded coupling portion 1472. The blocking portion 1452 radially protrudes from the latching pin 1442. The post 1462 and the threaded coupling portion 1472 can be located at respective opposite sides of the blocking portion 1452. The post 1462 can protrude through one of the plurality of Y-axis position limiting holes 1432. A size of the blocking portion 1452 can be larger than sizes of the post 1462 and threaded coupling portion 1472. The Y-axis position setting mechanism 1322 can further include a button 1482. The button 1482 can be threaded with the threaded coupling portion 1472 of the latching pin 1442.

The Y-axis position setting mechanism 1322 can further include a guiding block 1402. The guiding block 1402 can be fixed to the first fixing plate 1351. The guiding block 1402 can define a stepped through hole 1403. The stepped through hole 1403 can be substantially similar to the stepped through hole 1303 of the guiding block 1302. The stepped through hole 1403 can include a wide portion and a narrow portion. A size of the blocking portion 1452 can be substantially equal to a size of the wide portion of the stepped through hole 1403. The threaded coupling portion 1472 can pass through the stepped through hole 1403 and thread with the button 1482. When the latching pin 1442 is inserted into one of the Y-axis position limiting holes 1432, movement of the first fixing plate 1351, of the second fixing plate 1361, and of the operation platform 130 is restricted along the Y-axis. Thus, the first fixing plate 1351, the second fixing plate 1361, and the operation platform 130 are positioned along the Y-axis. When the latching pin 1442 is removed from the corresponding Y-axis position limiting hole 1432, a position of the first fixing plate 1351, of the second fixing plate 1361, and of the operation platform 130 can be adjusted along the Y-axis.

The Y-axis position setting mechanism 1322 can further include an elastic member 1492. The elastic member 1492 can be sleeved on the threaded coupling portion 1472 of the latching pin 1442. A first end portion of the elastic member 1492 can resist against the blocking portion 1452, and a second end portion of the elastic member 1492 can resist against a boundary between the wide portion and the narrow portion of the stepped through hole 1303 of the guiding block 1402. In the illustrated embodiment, the elastic member 1492 can be a spring.

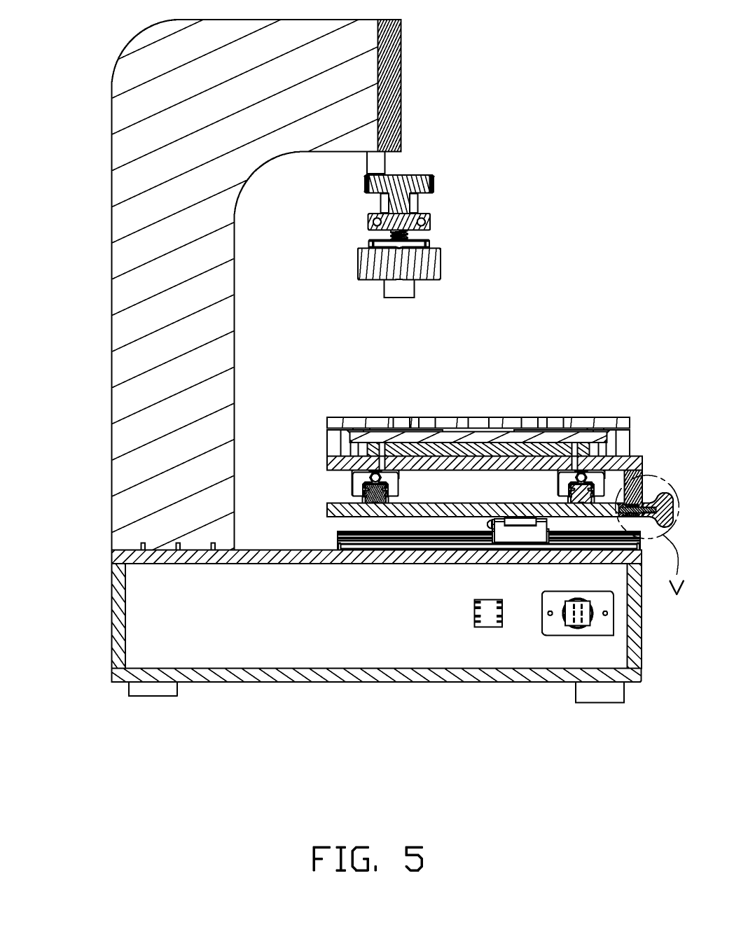

Referring to FIGS. 5-7, when in use, the post 1362 of the latching pin 1342 can be inserted into one X-axis position limiting hole 1332, and the post 1462 of the latching pin 1442 can be inserted into one Y-axis position limiting hole 1432. A first end portion of the elastic member 1392 can resist against the blocking portion 1352, and a second end portion of the elastic member 1392 can resist against a boundary between the wide portion and the narrow portion of the stepped through hole 1303 of the guiding block 1302. A first end portion of the elastic member 1492 can resist against the blocking portion 1452, and a second end portion of the elastic member 1492 can resist against a boundary between the wide portion and the narrow portion of the stepped through hole 1403 of the guiding block 1402.

When a position of the operation platform 130 needs to be adjusted along the X-axis direction, the button 1382 can be pulled outward. When the button 1382 is pulled outward, the latching pin 1342, which is threaded with the button 1382, is moved outward. Thus, the post 1362 can be removed from the corresponding X-axis position limiting hole 1332, and the elastic member 1302 can be compressed. When a pushing force is applied to the button 1382 along the X axis, the button 1382 can move the second fixing plate 1361 and the operation platform 130 along the X-axis. The second fixing plate 1361 and the operation platform 130 can be moved along the X-axis until the post 1362 aligns to a desired X-axis position limiting hole 1332. When the post 1362 aligns to the desired X-axis position limiting hole 1332, the button 1382 can be released, thereby allowing the elastic member 1392 to elastically restore and push the latching pin 1342 into the desired X-axis position limiting hole 1332. Thus, a position of the operation platform 130 along the X-axis can be adjusted easily.

A position of the first fixing plate 1351, the second fixing plate 1361, and the operation platform 130 can be adjusted along the Y-axis direction in a way substantially similar to adjusting the position of the second fixing plate 1361 and the operation platform 130 along the X axis, as described above.

The embodiments shown and described above are only examples. Many details are often found in the art such as the other features of a positioning device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A positioning device, comprising:
a base;
an extension arm fixed to the base;
a Z-axis control mechanism located on the extension arm;
a pressing member located on the Z-axis control mechanism; and
a manual control mechanism located on the extension arm, the manual control mechanism comprising:
an X-axis control mechanism comprising a position limiting plate and a latching pin, the position limiting plate defining a plurality of X-axis position limiting holes, the latching pin being configured to be alternatively inserted into one of the plurality of X-axis position limiting holes,
a Y-axis control mechanism comprising a position limiting plate and a latching pin, the position limiting plate defining a plurality of Y-axis position limiting holes, the latching pin of the Y-axis control mechanism being configured to be alternatively inserted into one of the plurality of Y-axis position limiting holes, and
an operation platform located above the X-axis control mechanism and the Y-axis control mechanism.

2. The positioning device of claim 1, wherein the X-axis control mechanism further comprises an X-axis guiding mechanism and an X-axis position setting mechanism, the X-axis guiding mechanism comprises an X-axis guiding member and an X-axis guiding rail coupled to the X-axis guiding member, the X-axis guiding rail is coupled to a top surface of a first fixing plate, the X-axis guiding member is coupled to a second fixing plate, the X-axis control mechanism further comprises a guiding block, the operation platform is coupled to the second fixing plate.

3. The positioning device of claim 2, wherein the X-axis position setting mechanism further comprises a guiding block, a button, the latching pin comprises a blocking portion, a post, and a threaded coupling portion, the guiding block is coupled to the second fixing plate, the blocking portion radially protrudes from the latching pin, the post and the threaded coupling portion are located at opposite sides of the blocking portion and coupled to the blocking portion, the post of the latching pin is configured to be alternatively inserted into one of the plurality of X-axis position limiting holes, the threaded coupling portion passes through the guiding block and threaded with the button.

4. The positioning device of claim 3, wherein the X-axis position setting mechanism can further comprises an elastic member, the elastic member is sleeved on the threaded coupling portion of the latching pin, a first end portion of the elastic member resists against the blocking portion and a second end portion of the elastic member resists against the guiding block.

5. The positioning device of claim 1, wherein the Y-axis control mechanism further comprises an Y-axis guiding mechanism and an Y-axis position setting mechanism, the Y-axis guiding mechanism comprises an Y-axis guiding member and an Y-axis guiding rail coupled to the Y-axis guiding member, the Y-axis guiding rail is fixed to a top surface of the base, the Y-axis guiding member is fixed to a first fixing plate.

6. The positioning device of claim 5, wherein the Y-axis position setting mechanism further comprises a guiding block, a button, the latching pin comprises a blocking portion, a post, and a threaded coupling portion, the blocking portion radially protrudes from the latching pin, the post and the threaded coupling portion are located at opposite sides of the blocking portion and coupled to the blocking portion, the post of the latching pin is configured to be alternatively inserted into one of the plurality of Y-axis position limiting holes, the threaded coupling portion passes through the guiding block and is threaded with the button.

7. The positioning device of claim 6, wherein the Y-axis position setting mechanism can further comprises an elastic member, the elastic member can be sleeved on the threaded coupling portion of the latching pin, a first end portion of the elastic member resists against the blocking portion and a second end portion of the elastic member resists against the guiding block.

8. A positioning device, comprising:
a base; and
a manual control mechanism comprising:
an X-axis control mechanism comprising a position limiting plate and a latching pin, the position limiting plate being arranged along an X axis and defining a plurality of X-axis position limiting holes, the latching pin being configured to be alternatively inserted into one of the plurality of X-axis position limiting holes,
a Y-axis control mechanism comprising a position limiting plate and a latching pin, the position limiting plate being arranged along a Y axis and defining a plurality of Y-axis position limiting holes, the Y axis being perpendicular to the X axis, the latching pin of the Y-axis control mechanism being configured to be alternatively inserted into one of the plurality of Y-axis position limiting holes, and
an operation platform located above the X-axis control mechanism and the Y-axis control mechanism.

9. The positioning device of claim 8, wherein the manual control mechanism further comprises a first fixing plate and a second fixing plate, the position limiting plate is positioned on a first fixing plate, the X-axis control mechanism further comprises a guiding block fixed to a second fixing plate and a button, the latching pin passes through the guiding block and threaded with the button, the operation platform is coupled to the second fixing plate.

10. The positioning device of claim 9, wherein the X-axis control mechanism further comprises an X-axis guiding member and an X-axis guiding rail coupled to the X-axis guiding member, the X-axis guiding rail is coupled to a top surface of the first fixing plate, the X-axis guiding member is coupled to a bottom surface of the second fixing plate.

11. The positioning device of claim 9, wherein the second fixing plate is parallel to the first fixing plate.

12. The positioning device of claim 9, wherein the latching pin comprises a blocking portion, a post, and a threaded coupling portion, the post and the threaded coupling portion are located at opposite sides of the blocking portion, the post of the latching pin is configured to be alternatively inserted into one of the plurality of X-axis position limiting holes, the threaded coupling portion passes through the guiding block and is threaded with the button.

13. The positioning device of claim 12, wherein a size of the blocking portion is larger than a size of the post and larger than a size of the threaded coupling portion.

14. The positioning device of claim 12, wherein the guiding block defines a stepped through hole, a size of the blocking portion is substantially equal to a size of the stepped through hole.

15. The positioning device of claim 12, wherein the X-axis control mechanism further comprises an elastic member, the elastic member is sleeved on the threaded coupling portion of the latching pin, a first end portion of the elastic member resists against the blocking portion and a second end portion of the elastic member resists against the guiding block.

16. The positioning device of claim 8, wherein the position limiting plate is positioned on the base, the Y-axis control mechanism further comprises a guiding block fixed to a first fixing plate and a button, the latching pin passes through the guiding block and is threaded with the button.

17. The positioning device of claim 16, wherein the latching pin comprises a blocking portion, a post, and a threaded coupling portion, the post and the threaded coupling portion are located at opposite sides of the blocking portion, the post of the latching pin is configured to be alternatively inserted into one of the plurality of Y-axis position limiting holes, the threaded coupling portion passes through the guiding block and threaded with the button.

18. The positioning device of claim 8 further comprising:
an extension arm fixed to the base;
a Z-axis control mechanism located on the extension arm; and
a pressing member located on the Z-axis control mechanism,
wherein, the Z-axis control mechanism comprises a macro-adjusting mechanism and a micro-adjusting mechanism coupled to the macro-adjusting mechanism, the pressing member can be coupled to the macro-adjusting mechanism.

19. The positioning device of claim 8, wherein the operation platform defines a plurality of through holes.

20. A positioning device comprising:
a base;
an extension arm coupled to the base;
a Z-axis control mechanism extending from the extension arm;
a pressing member coupled to the Z-axis control mechanism;
a manual control mechanism coupled to the extension arm, the manual control mechanism comprising:
an X-axis control mechanism having a position limiting plate defining a plurality of X-axis position limiting holes and a latching pin configured to be inserted into one of the plurality of X-axis position limiting holes,
a Y-axis control mechanism having a position limiting plate defining a plurality of Y-axis position limiting holes and a latching pin configured to be inserted into one of the plurality of Y-axis position limiting holes,
an operation platform positioned above the X-axis control mechanism and the Y-axis control mechanism.
